(19) United States
(12) Patent Application Publication
(10) Pub. No.: US 2010/0146507 A1
(43) Pub. Date: Jun. 10, 2010

(54) SYSTEM AND METHOD OF DELIVERY OF VIRTUAL MACHINE USING CONTEXT INFORMATION

(76) Inventors: Dong-oh KANG, Daejeon-city (KR); Kyuchang KANG, Daejeon-city (KR); Hyungjik LEE, Daejeon-city (KR); Miok CHAE, Daejeon-city (KR); Kiryong HA, Daejeon-city (KR); Joonyoung JUNG, Seoul (KR); Yunkyung PARK, Daejeon-city (KR); Jeunwoo LEE, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/629,960

(22) Filed: Dec. 3, 2009

(30) Foreign Application Priority Data
Dec. 5, 2008 (KR) 10-2008-0123498
Oct. 7, 2009 (KR) 10-2009-0095186

(51) Int. Cl. G06F 9/455

(52) U.S. Cl. 718/1

(57) ABSTRACT

There is provided a system of delivery of a virtual machine using context information. The system of delivery of a virtual machine includes: a context information manager that receives one or more user context information from a user terminal device; and a virtual machine generator that generates a virtual machine suitable for the user terminal device in accordance with the one ore more received user context information and outputs the generated virtual machine to the user terminal device.

### RELATED APPLICATIONS

The present application claims priority to Korean Patent Application Serial Number 10-2008-0123498, filed on Dec. 5, 2008 and Korean Patent Application Serial Number 10-2009-0095186, filed on Oct. 7, 2009, the entirety of which are hereby incorporated by reference.

### BACKGROUND OF THE INVENTION

1. Field of the Invention

The embodiment relates to a technology delivering a virtual machine to a terminal device of a user, and more particularly, to a system and a method of delivery of a virtual machine using user information, which can automatically deliver the virtual machine by using user context information.

2. Description of the Related Art

There was an inconvenience in that even the same application program should be separately designed to suit each hardware platform depending on a hardware platform where an application program operates at the time of developing the application program in the related art.

As a result, in order to develop an application program which is not dependent on the hardware platform, a virtual machine abstracting the hardware platform has been developed, and a representative example of the virtual machine is a Java virtual machine.

Users who want to use the virtual machine select a configuration of the virtual machine, and download and use it according to their needs. In other words, a plurality of virtual machines are stored in a server according to a user request or the application program and the user accesses the server through remote access to download and use the corresponding virtual machine.

However, since the known method of using the virtual machine needs to change and designate the configuration of the virtual machine every time, which is dependent on an environment of a user terminal device where the user uses the virtual machine or user context, the known method has a problem in that user convenience is deteriorated.

### SUMMARY OF THE INVENTION

An object of the present invention is to provide a system of delivery of a virtual machine which can automatically deliver the virtual machine according to user context information.

Another object of the present invention is to provide a method of delivery of a virtual machine using user context information.

In order to achieve the above-mentioned object, a system of delivery of a virtual machine according to a first aspect of the present invention includes: a context information manager that receives one or more user context information from a user terminal device; and a virtual machine generator that generates a virtual machine suitable for the user terminal device according to the one ore more received user context information and outputs the generated virtual machine to the user terminal device.

In order to achieve the above-mentioned object, a system of delivery of a virtual machine according to another aspect of the present invention includes: a virtual machine storage unit where a plurality of virtual machines corresponding to plural context information are generated and stored; a context information manager that receives one or more user context information from a user terminal device; and a comparison unit that compares the received user context information and the stored plural context information with each other.

The virtual machine delivery system extracts one virtual machine among the stored plural virtual machines in accordance with the comparison result of the comparison unit and outputs the one extracted virtual machine to the user terminal device.

In order to achieve the above-mentioned object, a method of delivery of a virtual machine using context information includes: receiving one or more user context information from a user terminal device; generating a virtual machine suitable for the user terminal device in accordance with the one or more received user context information; and outputting the generated virtual machine to the user terminal device.

According to an embodiment of the present invention, a system and a method of delivery of a virtual machine using context information can automatically generate and download an optimal virtual machine depending user context information, such that a user does not need to designate and input a configuration of the virtual machine every time in order to use the virtual machine, thereby improving user convenience.

Further, by extracting a virtual machine suitable for the user context information among a plurality of virtual machines configured in advance and transmitting the virtual machine to the user, the user can more rapidly use the virtual machine.

### BRIEF DESCRIPTION OF THE DRAWINGS

The drawings are described in order to more fully appreciate drawings cited in the detailed description of the present invention.

FIG. 1 is a schematic conceptual diagram of a system of delivery of a virtual machine using context information of the present invention;

FIG. 2 is a schematic block diagram of a system of delivery of a virtual machine using context information according to an embodiment of the present invention;

FIG. 3 is an operational flowchart of the system of delivery of a virtual machine shown in FIG. 2;

FIG. 4 is a schematic block diagram of a system of delivery of a virtual machine using context information according to another embodiment of the present invention;

FIG. 5 is an operational flowchart of the system of delivery of a virtual machine shown in FIG. 4; and

FIG. 6 is a diagram showing an operation example of a system of delivery of a virtual machine using context information according to the present invention.

### DETAILED DESCRIPTION OF THE PREFERRED EMBODIMENTS

The accompanying drawings illustrating embodiments of the present invention and contents described in the accompanying drawings should be reference in order to fully appreciate operational advantages of the present invention and objects achieved by the embodiments of the present invention.

Hereinafter, the present invention will be described in detail by describing preferred embodiments of the present invention with reference to the accompanying drawings. Like elements refer to like reference numerals shown in the drawings.

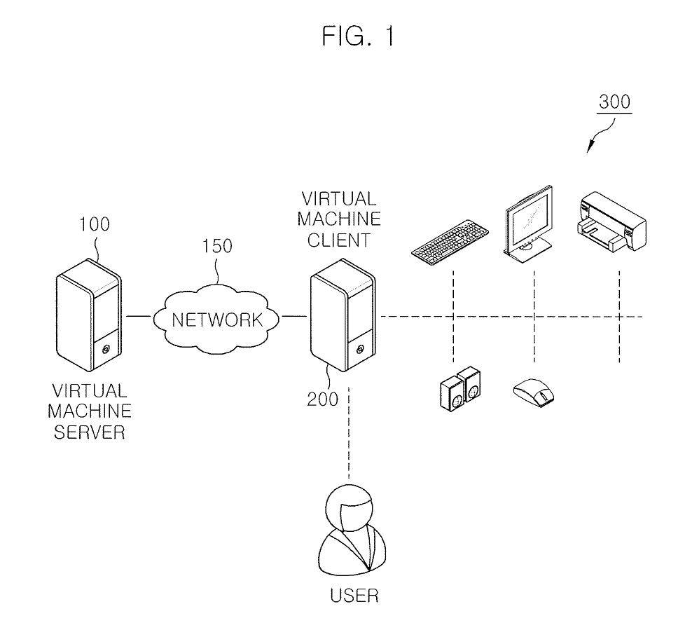

FIG. 1 is a schematic conceptual diagram of a system of delivery of a virtual machine using context information of the present invention.

Referring to FIG. 1, the virtual machine delivery system 300 may include a virtual machine server 100 and a virtual machine client, i.e., a user terminal device 200.

The virtual machine server 100 and the user terminal device 200 may be connected to each other through a network 150. The network 150 may be a wired/wireless network that can perform wired or wireless communication.

The user terminal device 200 may be a plurality of terminal devices which a user possesses and for example, may include a computer device including a PC and a notebook PC, a mobile device including a cellular phone, a personal multimedia device including a PMP, an IPTV which is accessible to the network, etc.

The user terminal device 200 may include a plurality of peripheral devices that are connected with the terminal device. In FIG. 1, as one example, the user terminal device 200 is the PC and a keyboard, a speaker, a monitor, a printer, a mouse, etc. may be included in the peripheral devices of the user terminal device 200.

The user can access the virtual machine server 100 through the network 150 by using the user terminal device 200 and can download the virtual machine from the virtual machine server 100.

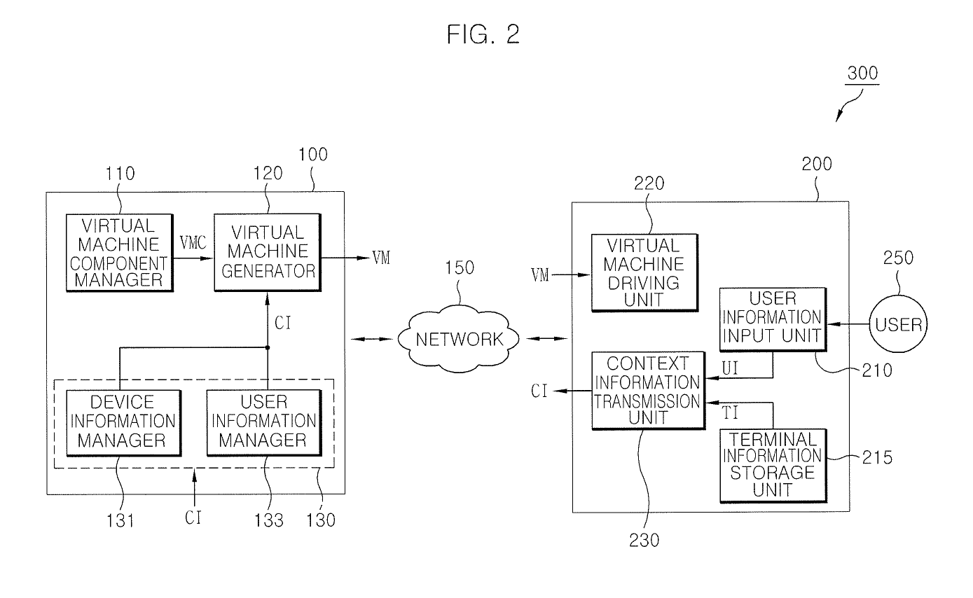

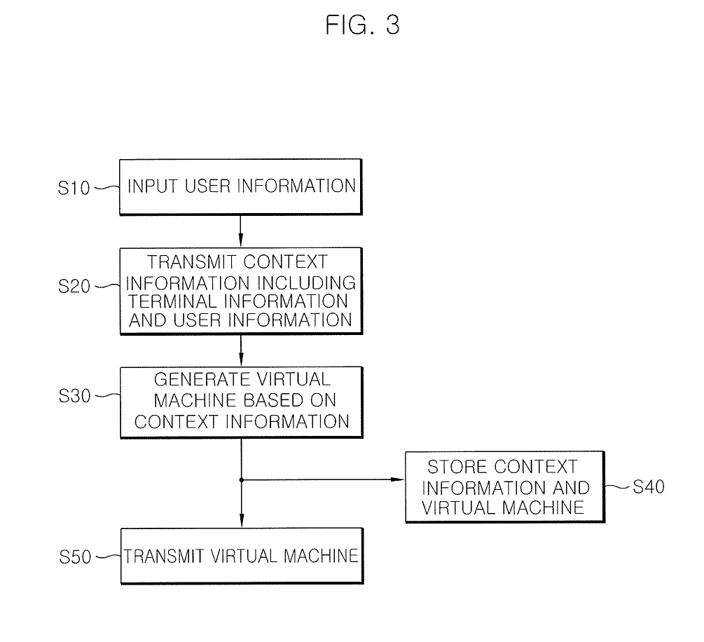

FIG. 2 is a schematic block diagram of a system of delivery of a virtual machine using context information according to an embodiment of the present invention and FIG. 3 is an operational flowchart of the system of delivery of a virtual machine shown in FIG. 2.

Referring to FIG. 2, the virtual machine delivery system 300 may include a virtual machine server 100, a user terminal device 200, and a network 150.

The virtual machine server 100 may include a virtual machine component manager 110, a virtual machine generator 120, and a user context information manager 130.

The virtual machine component manager 110 may manage a plurality of components (VMC) which the virtual machine generator 120 needs so as to generate the virtual machine and information of each of the components.

The plurality of components (VMC) may be stored and managed in an image form, for example, may include an application software image, a virtual machine OS image, a user personal data image, etc.

According to the embodiment, the plurality of components (VMC) are positioned in different servers and the virtual machine component manager 110 may request transmission of the plurality of components (VMC) to another server as necessary.

The virtual machine generator 120 can generate and output the virtual machine (VM) from the plurality of components (VMC) provided from the virtual machine component manager 110 according to user context information (CI) outputted from the user context information manager 130.

The virtual machine generator 120 can combine one or more components corresponding to (or which coincides with) the user context information (CI) among the plurality of components (VMC) and output the virtual machine (VM) generated by a combination result.

The user context information manager 130 can receive and manage the user context information (CI) provided from the user terminal device 200.

The user context information manager 130 can include a device information manager 131 and a user information manager 133.

The device information manager 131 can extract information on the user terminal device 200, i.e., terminal information (TI) from the received user context information (CI) and manage it.

The terminal information (TI) can include state information of resources such as a memory, an HDD, a CPU, peripheral device, etc. of the user terminal device 200, access information between the user terminal device 200 and the network 150, information on a program (alternatively, virtual machine) currently executed, or the like.

The user information manager 130 can extract information which the user inputs into the user terminal device 200, i.e., user information (UI) from the received user context information (CI) and manage it.

The user information (UI) can include, for example, personal information, information on a field utilizing the virtual machine, preference information, positional information, or the like.

The user terminal device 200 can include user information input unit 210, a terminal information storage unit 215, a context information transmission unit 230, and a virtual machine driving unit 220.

The user 250 can input the user information (UI) through the user information input unit 210. The user 250 accesses (alternatively, logs in) the user terminal device 200 through the user information input unit 210 to input the user information (UI). The user information input unit 210 may be a user interface such as a keyboard, a mouse, a touch pad, etc.

The terminal information (TI) of the user terminal device 200 can be stored in the terminal information storage unit 215. The terminal information storage unit 215 can periodically monitor internal constituent devices of the user terminal device 200, i.e., the CPU, the memory, the HDD, etc. and can thus update the terminal information (TI).

The context information transmission unit 230 can generate and output the user context information (CI) from the user information (UI) provided from the user information input unit 210 and the terminal information (TI) provided from the terminal information storage unit 215. According to the embodiment, only any one of the user information (UI) and the terminal information (TI) may be included in the user context information (CI).

The context information transmission unit 230 may output the user context information (CI) every predetermined time or output the user context information (CI) after a predetermined operation from the user 250, i.e., an operation for the user 250 to input the user information (UI) by accessing the user terminal device 200 is performed.

The user context information (CI) outputted from the context information transmission unit 230 can be transmitted to the virtual machine server 100 through the network 150.

The network 150 may be the wired/wireless network that can connect the virtual machine server 100 and the user terminal device 200 to each other.

Referring to FIGS. 2 and 3, the user 250 can input the user information (UI) through the user information input unit 210 of the user terminal device 200 (S10).

The context information transmission unit 230 of the user terminal device 200 can generate the user context information (CI) from the user information (UI) and the terminal information (TI) outputted from the terminal information storage unit 215 and transmit the generated user context information (CI) to the virtual machine server 100 through the network 150 (S20).

The user context information manager 130 of the virtual machine server 100 receives the user context information (CI) from the user terminal device 200 to output the received user context information as a control signal of the virtual machine generator 120. The virtual machine generator 120 can generate the virtual machine (VM) from the plurality of components (VMC) outputted from the virtual machine component manager 110 according to the user context information (CI) (S30).

The generated virtual machine (VM) is transmitted to the user terminal device 200 through the network 150 (S50) and the user terminal device 200 can drive the transmitted virtual machine (VM).

At this time, the virtual machine server 100 may store the user context information (CI) and the resulting generated virtual machine (VM) in a predetermined space of the server, i.e., the memory, etc. to construct a database (S40).

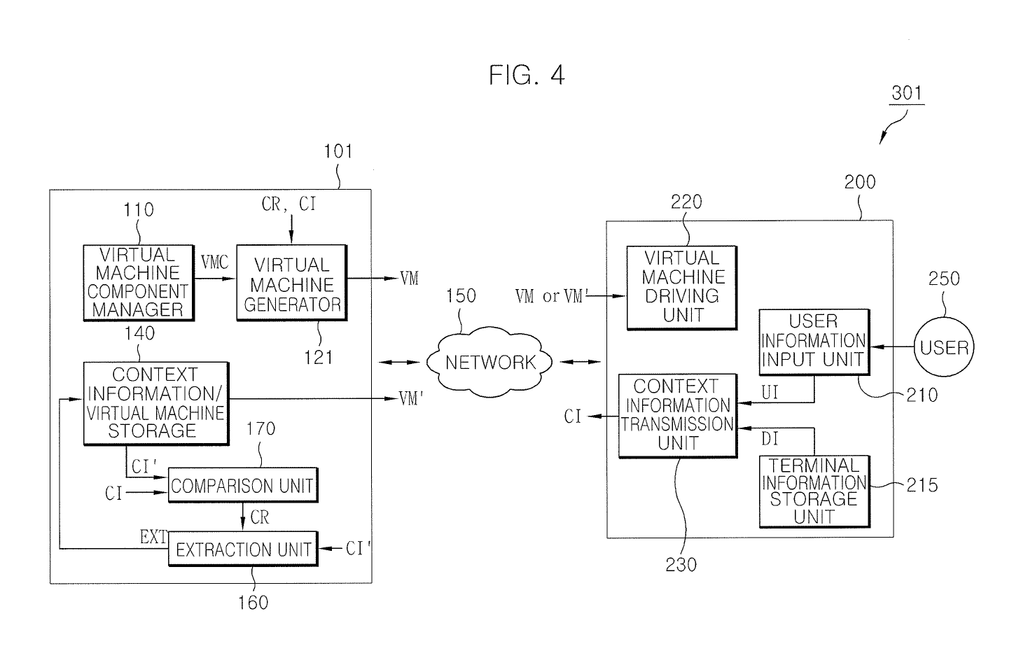

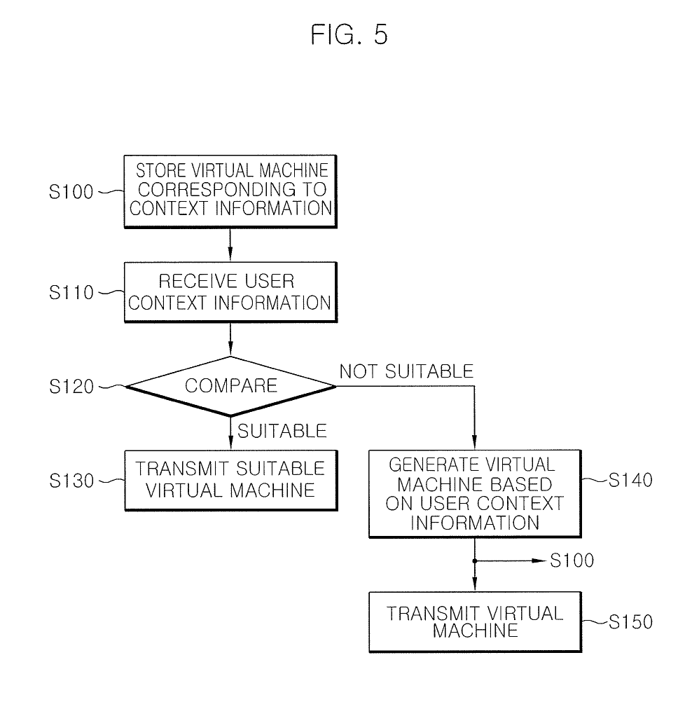

FIG. 4 is a schematic block diagram of a system of delivery of a virtual machine using context information according to another embodiment of the present invention and FIG. 5 is an operational flowchart of the system of delivery of a virtual machine shown in FIG. 4.

The virtual machine delivery system shown in FIG. 4 may have the same configuration as the virtual machine delivery system shown in FIG. 2 except for the following configuration. For example, the virtual machine delivery system 301 shown in FIG. 4 has the same configuration as the virtual machine delivery system 301 shown in FIG. 2 except for a fact that the virtual machine server 101 includes a context information/virtual machine storage unit 140, a comparison unit 170, and an extraction unit 160.

Referring to FIG. 4, the virtual machine delivery system 301 can include a virtual machine server 101, a user terminal device 200, and a network 150. The user terminal device 200 and the network 150 are the same as the user terminal device 200 and the network 150 shown in FIG. 2. Therefore, a description thereof will be omitted.

The virtual machine server 101 can include a virtual machine component manager 110, the virtual machine generator 121, the context information/virtual machine storage unit 140, the comparison unit 170, and the extraction unit 160.

The virtual machine component manager 110 and the virtual machine generator 121 are the same as the virtual machine component manager 110 and the virtual machine generator 120 as shown in FIG. 2. Therefore, a description thereof will be omitted.

A plurality of virtual machines matched for each of plural context information can be stored in the context information/virtual machine storage unit 140. The context information/virtual machine storage unit 140 accumulates and stores the virtual machine depending on the user context information generated by operating the previous virtual machine 101 and constructs the virtual machine as the database.

When the user context information (CI) is transmitted from the user terminal device 200, the comparison unit 170 can output a comparison result (CR) by comparing the plural context information stored in the context information/virtual machine storage unit 140 and the transmitted user context information (CI) with each other.

The comparison result (CR) outputted from the comparison unit 170 can be provided to the extraction unit 160 or the virtual machine generator 121 according to its property.

For example, when one context information same (alternatively, similar) as the user context information (CI) is present in the plural context information stored in the context information/virtual machine storage unit 140, the comparison unit 170 can output the comparison result (CR) to the extraction unit 160.

Further, when one context information same as the user context information (CI) is not present in the plural context information stored in the context information/virtual machine storage unit 140, the comparison unit 170 can output the comparison result (CR) to the virtual machine generator 121.

The extraction unit 160 can extract one context information from the plural context information stored in the context information/virtual machine storage unit 140 according to the comparison result (CR) outputted from the comparison unit 170 and output an extraction signal (EXT) for extracting one virtual machine corresponding to the one extracted context information to the context information/virtual machine storage unit 140.

The context information/virtual machine storage unit 140 can extract one virtual machine (VM') according to the extraction signal (EXT) and transmit the extracted virtual machine to the user terminal device 200 through the network 150.

Meanwhile, when the comparison result (CR) of the comparison unit 170 is outputted to the virtual machine generator 121, the virtual machine generator 121 can generate a new virtual machine (VM) by combining one or more components corresponding to the user context information (CI) among the plurality of components (VMC) and output the new generated virtual machine (VM) to the user terminal device 200 through the network 150.

Referring to FIGS. 4 and 5, the virtual machine server 101 can store the plurality of virtual machines corresponding to the plural context information (S100).

The user 250 can input the user information (UI) through the user information input unit 210 of the user terminal device 200 and the context information transmission unit 230 of the user terminal device 200 can generate the user context information (CI) from the user information (UI) and the terminal information (TI) outputted from the terminal information storage unit 215. The generated user context information (CI) can be transmitted to the virtual machine server 101 through the network 150 (S110).

The comparison unit 170 of the virtual machine server 101 can compare the user context information (CI) transmitted from the user terminal device 200 and the plural context information stored in the context information/virtual machine storage unit 140 with each other (S120).

According to the comparison result, when one context information among the plural context information coincides with the user context information (CI), the comparison unit 170 can output the comparison result (CR) to the extraction unit 160.

The extraction unit 160 can extract one context information among the plural context information stored in the context information/virtual machine storage unit 140 according to the comparison result (CR). The extraction unit 160 can output the extraction signal (EXT) for extracting one virtual machine corresponding to one context information to the context information/virtual machine storage unit 140.

The context information/virtual machine storage unit 140 can transmit a virtual machine (VM′) which coincides with the user context information (CI) to the user terminal device 200 through the network 150 (S130).

However, when context information which coincides with the user context information (CI) is not present in the plural context information according to the comparison result, the comparison unit 170 can output the comparison result to the virtual machine generator 121.

The virtual machine generator 121 can generate a new virtual machine (VM) from the plurality of components (VMC) outputted from the virtual machine component manager 110 according to the comparison result (CR) and the user context information (CI) (S140).

The generated new virtual machine (VM) is transmitted to the user terminal device 200 through the network 150 (S150) and the user terminal device 200 can drive the new transmitted virtual machine (VM).

At this time, the virtual machine server 101 transmits the user context information (CI) and the resulting generated new virtual machine (VM) to the context information/virtual machine storage unit 140 to store them in the context information/virtual machine storage unit 140.

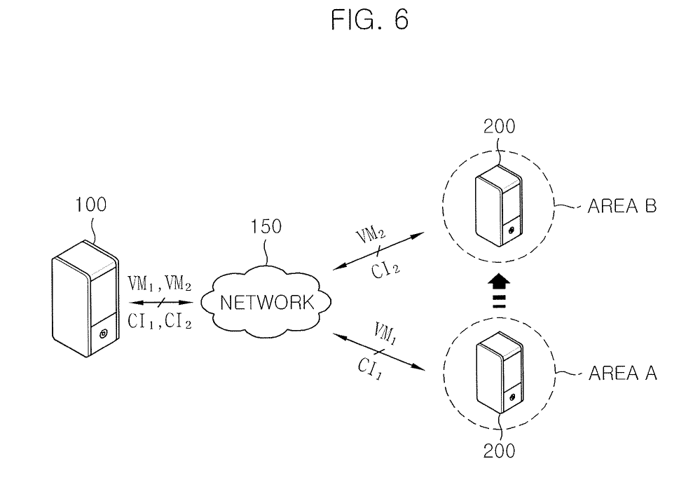

FIG. 6 is a diagram showing an operation example of a system of delivery of a virtual machine using context information according to the present invention.

In the embodiment, for convenience of description, a case in which the virtual machine delivery system shown in FIG. 2 is used will be described as an example. However, the present invention is not limited thereto and the virtual machine delivery system shown in FIG. 4 may be used.

Referring to FIG. 6, the user can transmit first user context information (CI1) to the virtual machine server 100 through the network 150 by using the user terminal device 200 in an area A.

The virtual machine server 100 can transmit a first virtual machine (VM1) generated according to the first user context information (CI1) to the user terminal device 200 in the area A through the network 150.

Meanwhile, the user plans to move from the area A to an area B after a predetermined time and plans to use a new virtual machine after moving to the area B.

Therefore, the user can add and transmit the moving plan from the area A to the area B and a usage plan for a virtual machine to be used at this time, i.e., a second virtual machine (VM) in addition to the first user context information (CI1) to the virtual machine server 100.

According to the embodiment, the user may transmit the first user context information (CI1) only in the area A to the virtual machine server 100 and at this time, the user may transmit new second user context information (CI2) in the area B after moving from the area A to the area B to the virtual machine server 100.

When the user moves from the area A to the area B after a predetermined time, the user terminal device 200 in the area B can transmit new user context information, i.e., the second user context information (CI2) to the virtual machine server 100 through the network 150. User positional information in the area B can be included in the second user context information (CI2).

The virtual machine server 100 can transmit to the user terminal device 200 of the area B the second virtual machine (VM2) generated according to the first user context information (CI1) transmitted from the area A and the second user context information (CI2) transmitted from the area B by the user.

Although the preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

What is claimed is:

1. A system of delivery of a virtual machine using context information, comprising:
a context information manager that receives one or more user context information from a user terminal device; and
a virtual machine generator that generates a virtual machine suitable for the user terminal device according to the one or more user context information and outputs the generated virtual machine to the user terminal device.

2. The system of delivery of a virtual machine using context information according to claim 1, wherein the context information manager receives a user information which a user transmits through the user terminal device or a device information of the user terminal device as the user context information.

3. The system of delivery of a virtual machine using context information according to claim 1, further comprising:
a virtual machine component manager that stores a plurality of virtual machine components for generating the virtual machine,
wherein the virtual machine generator extracts one or more components suitable for one or more user context information from the virtual machine components manager and generates the virtual machine by combining the one or more extracted components.

4. A system of delivery of a virtual machine using context information, comprising:
a virtual machine storage unit where a plurality of virtual machines corresponding to plural context information are generated and stored;
a context information manager that receives one or more user context information from a user terminal device; and
a comparison unit that compares the received user context information and the stored plural context information with each other,
wherein the virtual machine delivery system extracts one virtual machine among the stored plural virtual machines in accordance with the comparison result of the comparison unit and outputs the one extracted virtual machine to the user terminal device.

5. The system of delivery of a virtual machine using context information according to claim 4, wherein the context information manager receives a user information transmitted through the user terminal device by the user or a device information of the user terminal device as the user context information.

6. The system of delivery of a virtual machine using context information according to claim 4, further comprising:
an extraction unit that extracts one context information which coincides with the user context information from the plural context information in accordance with the comparison result of the comparison unit and outputs the one virtual machine corresponding to the one context information extracted from the plurality of virtual machines.

7. The system of delivery of a virtual machine using context information according to claim 4, further comprising:
a virtual machine generator,
wherein when the plurality of context information does not coincide with the user context information, the virtual machine generator generates a new virtual machine suitable for the user terminal device in accordance with the received user context information and outputs the generated virtual machine to the user terminal device.

8. The system of delivery of a virtual machine using context information according to claim 7, further comprising:
a virtual machine component manager that stores a plurality of virtual machine components for generating the new virtual machine,
wherein the virtual machine generator extracts one or more components suitable for the user context information from the virtual machine component manager and generates the new virtual machine by combining the one or more extracted components.

9. A method of delivery of a virtual machine using context information, comprising:
receiving one or more user context information from a user terminal device;
generating a virtual machine suitable for the user terminal device in accordance with the one or more received user context information; and
outputting the generated virtual machine to the user terminal device.

10. The method of delivery of a virtual machine using context information according to claim 9, wherein the generating the virtual machine includes:
receiving user information or device information of the user terminal device as the user context information; and
generating the virtual machine by combining one or more components corresponding to the user context information among a plurality of virtual machine components.

11. The method of delivery of a virtual machine using context information according to claim 9, further comprising:
storing a plurality of virtual machines corresponding to plural context information,
wherein the generating the virtual machine includes,
comparing the plural context information and the user context information with each other; and
extracting one virtual machine among the plurality of virtual machines in accordance with the comparison result.

12. The method of delivery of a virtual machine using context information according to claim 11, wherein the extracting one virtual machine extracts one context information which coincides with the user context information from the plural context information in accordance with the comparison result and outputs the one virtual machine corresponding to the one context information extracted from the plurality of virtual machines.

13. The method of delivery of a virtual machine using context information according to claim 11, wherein in accordance with the comparison result, when the plural context information does not coincide with the user context information, the generating the virtual machine generates and outputs a new virtual machine suitable for the user terminal device by combining one or more components corresponding to the user context information among the plurality of virtual machine components.

14. The method of delivery of a virtual machine using context information according to claim 11, wherein the receiving one or more user context information receives user information or device information of the user terminal device from the user terminal device.
